(19) United States
(12) Patent Application Publication
(10) Pub. No.: US 2011/0224348 A1
(43) Pub. Date: Sep. 15, 2011

(54) PROCESS FOR PREPARING A COATING COMPOSITION FOR PAPER AND BOARD

(75) Inventors: Esko Aarni, Siuntio (FI); Vesa Nuutinen, Helsinki (FI); Mari Ojanen, Espoo (FI)

(73) Assignee: KEMIRA OYJ, Helsinki (FI)

(21) Appl. No.: 13/130,902

(22) PCT Filed: Nov. 23, 2009
(86) PCT No.: PCT/FI09/50948

§ 371 Date: May 24, 2011

(30) Foreign Application Priority Data
Nov. 24, 2008 (FI) 20086123

(51) Int. Cl. C08K 3/26

(52) U.S. Cl. 524/425; 524/426

(57) ABSTRACT

A process for preparing a dry coating composition for paper and board includes mixing at least one pigment and at least one binder and pulverizing the obtained mixture, and wherein 25% to 100% of the pigment has particle size D₉₀ from 10 μm to 50 μm before mixing with the binder. Also described is the use of pigments having a particle size D₉₀ from 10 μm to 50 μm in the production of pulverized dry coating composition for paper and board for improving the surface strength of a coating, which is made by dry coating a paper or board with the dry coating composition.

### FIELD OF THE INVENTION

The present invention is in the field of paper coating materials. The invention relates to a process for preparing a dry coating composition for paper and board, wherein the process comprises mixing at least one pigment and at least one binder and pulverizing the obtained mixture.

### BACKGROUND OF THE INVENTION

Conventional paper coatings are applied on a paper substrate as water containing coating colors. These coating formulations are prepared by mixing solids of suitable properties, such as inorganic pigments, binders and additives, with water.

Because the conventional coating mixes are applied on the surface of the paper web as water-based slurry, the water carried over to the web by the coating mix must be removed and therefore effective drying is needed after coating. The higher the web speed, the higher drying capacity is needed and the longer becomes the dryer section. Drying is also an energy-intensive process and the investment costs of a dryer section are high.

The above described problem with the water containing coatings can be avoided by a dry surface treatment process in which dry coating powder is applied on a web. For example WO 2004/044323 (Metso Paper Inc.) discloses a method for coating a web of paper by a dry coating powder. The method comprises the step of applying the coating powder to at least one side of the moving web. The coating powders include inorganic materials and polymeric binder material.

The dry surface treatment technology is still under development. Especially the coating materials used need to be improved. Many different kinds of coating compositions are known from the prior art. US 2005/0006041 (Omya Ag) discloses a composite compositions of co-structured or co-adsorbed fillers containing at least two different types of mineral or organic pigments and their use in papermaking for the coating. This composition contains at least one pigment having a surface with at least one hydrophilic site and at least one pigment having at least one organophilic site.

WO 01/00712 (Neste Chemicals Oy) discloses dry pigment granulates for paper coating, especially for fine paper. The pigment granulate comprises 95-99.5 wt-% of organic polymer pigment, 0-94.5 wt-% of inorganic pigment and 0.5-5 wt-% of a binder or a mixture of binders and the particle size of the granulate is 4-400 μm.

WO 2006/050873 (Basf Ag) discloses a paper coating slip containing at least one inorganic pigment, in particular white pigments, and, in relation to 100 weight parts of the inorganic pigments, less than 40 weight parts of organic polymers, and less than 25 weight parts of water or other solvents with a boiling point lower than 150° C. at 1 bar. The paper coating slips should have as low content as possible of water or solvents and they should adhere well to paper.

One of the problems related to the coating by the dry surface treatment process is that these known coating powders results in coatings having quality that is unacceptable for high speed printing. Pick is the name commonly given to damage to the paper surface occurring during the printing operation. When the printing form is lifted from the paper, the ink exerts on the paper a force, which increases with increasing viscosity and tack of the ink and with increasing printing speed. When this force exceeds a critical value, which depends on the paper, the surface of the paper is damaged. The minimum printing speed at which pick occurs is a measure of the pick resistance of the paper. Pick velocity [m/s] is the velocity at which pick of the surface on the printed paper begins under the conditions defined in the International standard ISO 3783 (IGT type tester). This pick resistance measurement can be used to describe the surface strength of the paper.

Typically the pick resistance problem has been tried to solve by modifying the binder material used in the coating composition. In the book series of Papermaking Science and Technology, Book 11 “Pigment Coating and Surface Sizing of Paper” discloses on page 210 that it is well known that dry pick strength increases with decreasing particle size of latexes and increasing latex carboxylation. Thus, it is generally believed that the smaller the particle size of the binder the better coating strength will be. However, the known coating compositions do not have a surface strength that is high enough, even if small particle size binders are used (i.e. below 150 nm), and because for economical reasons it is not reasonable to raise the surface strength by increasing binder dosage, there is a need for the development of new dry coating powders for improving the surface strength.

Particle size of the pigment is also known to affect to the properties of the coating composition. In conventional wet coating mixes (water-based slurries) it is generally known that small particle size is advantageous and therefore “fine” pigments i.e. particles having particle size D₉₀ below 2 μm has been used in coating composition (D₉₀ diameter is a value that indicates a 90% threshold of the tested population i.e. 90% of the particles are smaller than D₉₀ value). For “normal” particle sized coating pigments this value is 80% (D₈₀ 2 μm) and for “coarse” pigments less than 70% (D₇₀ 2 μm). Because the smoothness of the paper is an essential parameter and because the general belief in the art was that coarse particles lowers the surface strength, very coarse pigments having particle size D₉₀ above 10 μm have been considered to be unsuitable for coating mixes.

### DESCRIPTION OF THE INVENTION

An object of the present invention is thus to provide a process for preparing a dry coating composition for paper and board so as to alleviate the above disadvantages. The objects of the invention are achieved by a pulverized dry coating composition and a process for preparing it, which composition and process are characterized by what is stated in the independent claims. The preferred embodiments of the invention are disclosed in the dependent claims.

The invention is based on the realization that by including bigger pigment particles to the mixture from which the coating powder is produced, the final coating quality (surface strength) can be improved. Especially it was realized that the particle size of the pigment is one of the determinant factors of the final surface strength of the coating. Against the general knowledge in the field of the art, it was surprisingly found out that substantially bigger particle size of the pigment than normally used gave better surface strength.

The use pigment particles that have a smaller specific surface area (SSA) than the conventional pigments improve the final surface strength of the coating. Specific surface area (SSA) is a material property of solids which measures the total surface area per unit of mass. SSA is defined by surface area divided by mass (with units of m²/kg). Without binding to any theory, it is believed that the surface strength of the coating is improved at least partly because before the pulverization the ratio between the amount of the binder to the specific surface area of the pigment is bigger, thus the pigment particles are more completely covered with the binder. Keeping the amount of the binder unchanged and decreasing the SSA of the pigment increases the above-mentioned ratio. On the other hand this gives the possibility to decreases the amount of the binder, which in turn decreases the costs, because typically the binder is much more expensive material than the pigment. In a preferred embodiment of the present invention 25% to 100% of the pigment particles have a specific surface area below 3 m²/kg before mixing with the binder. In one embodiment of the invention 25% to 100% of the pigment particles have a specific surface area from 0.5 to 1.0 m²/kg before mixing with the binder.

As a first aspect the present invention provides a process for preparing a dry coating composition for paper and board, wherein the process comprises mixing at least one pigment and at least one binder and pulverizing the obtained mixture. The process is characterized in that 25% to 100% of the pigment has particle size D₉₀ from 10 μm to 50 μm before mixing with the binder. Preferably 25% to 100% of the pigment has a particle size D₉₀ from 20 μm to 40 μm and more preferably from 30 μm to 40 μm before mixing with the binder. In an embodiment of the invention the particle size distribution is such that at least one pigment has a particle size D₅₀ from 10 μm to 20 μm before mixing with the binder, meaning that 50% of the particles are smaller and 50% are bigger than corresponding limit value from 10 μm to 20 μm.

In order to optimize the optical and printing properties of the coated paper or board, especially gloss and opacity as well as surface strength, the dry coating composition of the present invention may contain up to 75% of pigment particles having a particle size D₉₀ below 2 μm before mixing with the binder. If the dry coating composition contains two pigments having different particle size distributions, then the mixture has a bimodal particle size distribution. Such a bimodal particle size distribution is a preferred embodiment of the invention.

In the process for preparing a dry coating composition for paper and board, pigment and binder are mixed together. This may be done by mixing about 5 to 20 parts per weight (ppw) of the binder with 100 ppw of the pigment and pulverizing the obtained mixtures. The binder dosage is typically between 10-15 parts per 100 parts inorganic particles. The mixing can be performed with or without additional water. After mixing the obtained mixture is dried by a convenient manner such as spray drying or freeze drying. Dry mixture is then ground for example with a jet mill and then coating composition is recovered in dry powder form. Typically the dry coating composition according to the present invention is pulverized to a particle size D₉₀ from 5 μm to 15 μm.

The obtained coating powder can be used for coating a paper substrate in a dry coating method. The dry coating composition may also comprise other additives, such as optical clarifier or antiblocking agent.

In the present invention the pigment used can be any inorganic pigment or mixture of pigments typically used in paper coatings, such as ground calcium carbonate (GCC). Other possible pigments include natural calcium carbonate, for example chalk, calcite, marble or any other form of calcium carbonate, natural or synthetic precipitated silicates, calcium sulfate, titanium dioxide, talcs, micas, clays, calcined clays, zinc oxide, other metal oxides, hydroxides, sulfates and carbonates such as satin white, crystalline and amorphous aluminum hydroxides.

By using a specific polymeric binder composition in the coating composition the final coating quality, namely the surface strength, may be further improved. Suitable binders to be used in the present invention include synthetic polymers and natural polymers, especially thermoplastic polymers such as styrene butadiene copolymer or styrene/butyl acrylate/acrylic acid copolymer.

Another aspect of the present invention is a pulverized dry coating composition for paper and board obtainable by the process according to the present invention. The pulverized dry coating composition comprises a mixture of at least one pigment and at least one binder and is preferably in the form of powder that has a particle size D₉₀ from 5 μm to 15 μm. Preferably at least 50% of the pigment particles in the pulverized mixture have been obtained from pigments having a particle size from 20 μm to 50 μm.

The present invention provides also an intermediate product for pulverized dry coating composition for paper and board, wherein the intermediate product contains at least one pigment and at least one binder, and the pigment has a particle size D₉₀ from 10 μm to 50 μm. In one embodiment of intermediate product the amount of binder is from 5 to 20 parts by weight, preferably from 10 to 15 parts by weight, per 100 parts of the pigment.

Still another aspect of the present invention is the use of pigments having a particle size D₉₀ from 10 μm to 50 μm in the production of pulverized dry coating composition for paper and board for improving the surface strength of a coating, which is made by dry coating a paper or board with said dry coating composition.

### EXAMPLES

In the performed experiments 10 or 15 parts of binders were mixed with 100 parts pure pigments or with pigment blends in water state. The pigment used in the examples was ground calcium carbonate (GCC). There were two different GCC having different particle sizes.

| | Particle size ≦D₅₀ | Particle size D₉₀ |
|---|---|---|
| | [μm] | [μm] |
| GCC “fine” | 0.8 | 2 |
| GCC “coarse” | 16 | 35 |

Particle size properties referred to in the present application are measured in a well-known manner by sedimentation of the particle material in a fully dispersed condition in an aqueous medium using a SEDIGRAPH 5100 machine as supplied by Micromeretics Corporation. The measurements were made in water at the standard temperature of 35° C.

BET specific surface areas (SSA) were measured by N₂-adsorption using Quantachrome NOVA 4000e surface area & pore size analyzer. The freeze dried samples were measured after being degassed in vacuum for 1 h at 200° C. In the analysis the specific surface areas were calculated by using the multiple-point BET method.

The binders used were Binder 1 (styrene butadiene copolymer, Plextol SB 750, T_{g}=58° C., particle size 170 nm) and Binder 2 (styrene butyl acrylate acrylic acid copolymer, T_{g}=47° C., particle size 260 nm). The mixtures were freeze dried and micronized in fluidized bed jet mill of the type Alpine AFG 100. Powders thus obtained having a particle size D₉₀ 3-13 μm were applied on paper substrate (base paper 37 g/m²) using Nordson Versa Spray II manual spray gun. The coat weights varied between 5-11 g/m².

The fixing of coating powder on a base paper was done by thermo-mechanical treatment using laboratory calendar (DT Paper Science; heated steel roll, polymer covered backing roll). In fixing each sample was run trough four calender nips with following condition. The first three nips: the calendering speed 4 m/min, temperature of heated roll was 150° C. and the nip load 64 kN/m. Siliconised baking paper was used to prevent sticking onto the hot calender roll. The last fixing nip was done without siliconised baking paper in the calendering speed 4 m/min, temperature of heated roll was 150° C. and the nip load 164 kN/m.

TABLE 1
Specific surface areas and particle size distributions of pigment blends

| Pigment blend, (%) | | | Particle size distribution | | |
|---|---|---|---|---|---|
| GCC | GCC | SSA | D₉₀ | D₅₀ | <2 μm |
| “coarse” | “fine” | [m²/g] | [μm] | [μm] | % |
| 100 | 0 | 0.5 | 31.8 | 12.4 | 7.0 |
| 75 | 25 | 3.4 | 28.3 | 8.9 | 22.4 |
| 50 | 50 | 6.3 | 24.4 | 2.1 | 43.6 |
| 25 | 75 | 9.0 | 15.2 | 1.0 | 63.6 |
| 0 | 100 | 12.0 | 1.9 | 0.8 | 81.5 |

The coating quality of dry coated papers was analyzed by determining the IGT surface strength.

The effect of pigment blend on the IGT surface strength (dry coated papers) can be seen from Table 2. The results show that IGT surfaced strength >1.0 m/s can be obtained with dry coating composition containing only 10 parts binder per 100 parts pigment when the amount of coarse pigment particles was 75%. When the amount of coarse pigment was 100%, as high as 2.0 m/s result was obtained using only 10 parts binder per 100 parts pigment.

TABLE 2
IGT surface strength results

| Pigment blend, (%) | | IGT surface strength, (m/s) | | |
|---|---|---|---|---|
| GCC | GCC | Binder 1 | Binder 1 | Binder 2 |
| “coarse” | “fine” | 15 parts | 10 parts | 10 parts |
| 100 | 0 | 2.71 | 2.00 | |
| 75 | 25 | | 1.18 | 1.21 |
| 50 | 50 | 1.33 | 0.80 | 0.95 |
| 25 | 75 | | 0.53 | |
| 0 | 100 | 0.69 | 0.32 | |

The results show that by right selection of pigments for coating powder the final coating quality (surface strength) can be improved. Especially the results show that higher surface strength may be obtained with smaller amount of binder when using bigger pigment particles in the production of the coating composition.

1. A process for preparing a dry coating composition for paper and board, wherein the process comprises mixing at least one pigment and at least one binder and pulverizing the obtained mixture, characterized in that 10% to 100% of the pigment has particle size D₉₀ from ≧10 μm before mixing with the binder.

2. The process according to claim 1, characterized in that 15% to 100% of the pigment has particle size D₉₀ from ≧10 μm before mixing with the binder.

3. The process according to claim 1, characterized in that 25% to 100% of the pigment has particle size D₉₀ from ≧10 μm before mixing with the binder.

4. The process according to claim 1, characterized in that 10% to 100% the pigment has particle size D₉₀ from 10 μm to 50 μm before mixing with the binder.

5. The process according to claim 1, characterized in that 10% to 100% of the pigment has particle size D₉₀ from 20 μm to 40 μm before mixing with the binder.

6. The process according to claim 1, characterized in that 10% to 100% of the pigment has particle size D₉₀ from 30 μm to 40 μm before mixing with the binder.

7. The process according to claim 1, characterized in that the obtained mixture is pulverized to a particle size D₉₀ from 2 μm to 15 μm.

8. The process according to claim 1, characterized in that the amount of binder in the mixture is from 5 to 20 parts by weight, preferably from 10 to 15 parts by weight, per 100 parts of the pigment.

9. The process according to claim 1, characterized in that at least one pigment in the mixture comprises inorganic particles.

10. The process according to claim 9, characterized in that said inorganic particles are selected from a group comprising natural and synthetic calcium carbonate, such as chalk, calcite, marble and any other form of calcium carbonate, natural and synthetic precipitated silicates, calcium sulfate, titanium dioxides, talcs, micas, clays, calcined clays, zinc oxide, other metal oxides, hydroxides, sulfates and carbonates such as satin white, crystalline and amorphous aluminum hydroxides.

11. The process according to claim 1, characterized in that the binder is thermoplastic polymer.

12. The process according to claim 11, characterized in that the thermoplastic polymer is obtainable by free radical emulsion polymerization of ethylenically unsaturated monomers.

13. The process according to claim 1, characterized in that the binder is styrene butadiene copolymer or styrene/butyl acrylate/acrylic acid copolymer.

14. The process according to claim 1, characterized in that up to 85% of the pigments has particle size ≦2 μm before mixing with the binder.

15. The process according to claim 1, characterized in that 10% to 100% of the pigment particles have a specific surface area below 3 m²/kg before mixing with the binder.

16. Pulverized dry coating composition for paper and board obtainable by a process according to claim 1.

17. Pulverized dry coating composition according to claim 16, characterized in that the powder has a particle size D₉₀ from 2 μm to 15 μm.

18. Pulverized dry coating composition for paper and board comprising a mixture of at least one pigment and at least one binder, characterized in that the dry coating composition has a particle size of D₉₀ from 2 μm to 15 μm, and at least 10% of the pigment particles in the pulverized mixture have been obtained from pigments having a particle size D₉₀ from 10 μm.

19. Intermediate product for pulverized dry coating composition for paper and board characterized in that the intermediate product contains at least one pigment and at least one binder, wherein the pigment has a particle size D₉₀ from 10 μm to 50 μm.

20. Intermediate product according to claim 19, characterized in that the amount of binder is from 5 to 20 parts by weight, preferably from 10 to 15 parts by weight, per 100 parts of the pigment.

21. Intermediate product according to claim 19, characterized in that at least one pigment in the mixture consists of inorganic particles that are selected from a group comprising natural and synthetic calcium carbonate, such as chalk, calcite, marble and any other form of calcium carbonate, natural and synthetic precipitated silicates, calcium sulfate, titanium dioxides, talcs, micas, clays, calcined clays, zinc oxide, other metal oxides, hydroxides, sulfates and carbonates such as satin white, crystalline and amorphous aluminum hydroxides.

22. (canceled)
